(19) United States
(12) Patent Application Publication
(10) Pub. No.: US 2018/0152515 A1
(43) Pub. Date: May 31, 2018

(54) File Storage Method and Apparatus for Instant Communication Messages

(71) Applicant: Alibaba Group Holding Limited, Grand Cayman (KY)

(72) Inventors: Guangqian Dong, Hangzhou (CN); Hang Chen, Hangzhou (CN); Zhenhao WU, Hangzhou (CN)

(73) Assignee: Alibaba Group Holding Limited

(21) Appl. No.: 15/881,591

(22) Filed: Jan. 26, 2018

Related U.S. Application Data
(63) Continuation of application No. PCT/CN2016/090291, filed on Jul. 18, 2016.

(30) Foreign Application Priority Data
Jul. 27, 2015 (CN) 201510446721.X

(51) Int. Cl. H04L 29/08; H04L 12/58

(52) U.S. Cl. CPC H04L 67/1097; H04L 67/06; H04L 51/04

(57) ABSTRACT

A method and an apparatus for storing a file of an instant communication message are disclosed. The method may include obtaining an instant communication message received by an instant communication application; determining that a file is included in the instant communication message; and storing the file in a cloud storage space corresponding to the instant communication application. Through the technical solutions of the present disclosure, a combination of an instant communication application and a cloud storage function can be implemented to perform a secure and effective storage of files in instant communication messages and to help a user to view and use thereof at a later time.

### CROSS REFERENCE TO RELATED PATENT APPLICATIONS

This application claims priority to and is a continuation of PCT Patent Application No. PCT/CN2016/090291 filed on 18 Jul. 2016, and is related to and claims priority to Chinese Patent Application No. 201510446721.X, filed on 27 Jul. 2015, entitled “File Storage Method and Apparatus for Instant Communication Messages,” which are hereby incorporated by reference in their entirety.

### TECHNICAL FIELD

The present disclosure relates to the technological field of communications, and particularly to file storage methods and apparatuses for instant communication messages.

### BACKGROUND

Along with the continuous development of mobile technologies, instant communication has become a very important communication method. Furthermore, as the number of functions integrated in an instant communication application has increased, the instant communication application has gradually been applied in various aspects of the daily lives, studies, work, etc., of people.

A user sometimes needs to view historical messages of instant communications, viewing instant communication messages in a certain time period. Accordingly, an instant communication application in a related technology records instant communication messages in a historical message file, to allow viewing at a later time.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

In view of the above, the present disclosure provides a file storage method and a file storage apparatus for instant communication messages, which can achieve a combination of an instant communication application and a cloud storage function, and safely and effectively store files in instant communication messages, thus facilitating a user to view and use at a later time.

In order to achieve the above goals, the present disclosure provides the following technical solutions.

In implementations, a file storage method for an instant communication message is provided, which includes obtaining an instant communication message received by an instant communication application; determining that a file is included in the instant communication message; and storing the file in a cloud storage space corresponding to the instant communication application.

In implementations, a file storage method for an instant communication message is provided, which includes determining a file received by an instant communication application, the file being included in instant communication message(s) received by the instant communication application; and storing the file into a cloud storage space corresponding to the instant communication application.

In implementations, a file storage apparatus for an instant communication message is provided, which includes an acquisition unit used for obtaining an instant communication message received by an instant communication application; a determination unit used for determining that a file is included in the instant communication message; and a storage unit used for storing the file in a cloud storage space corresponding to the instant communication application.

In implementations, a file storage apparatus for an instant communication message is provided, which includes a determination unit used for determining a file received by an instant communication application, the file being included in instant communication message(s) received by the instant communication application; and a storage unit used for storing the file into a cloud storage space corresponding to the instant communication application.

In implementations, a method for notifying an update is provided, which includes receiving a notification message from a cloud storage space that corresponds to an instant communication application, the notification message being related to an occurrence of a file update in a storage space of the cloud storage space corresponding to any one group; and presenting the notification message in a message receiving window of the any one group.

In implementations, an apparatus for notifying an update is provided, which includes a receiving unit used for receiving a notification message from a cloud storage space that corresponds to an instant communication application, the notification message being related to an occurrence of a file update in a storage space of the cloud storage space corresponding to any one group; and a display unit used for presenting the notification message in a message receiving window of the any one group.

As can be seen from the above technical solutions, by combining a cloud storage function with an instant communication application, the present disclosure enables files in the instant communication application to be automatically stored into a cloud storage space, thus facilitating a user to query and view thereof at a later time. Furthermore, as the files are stored in the cloud storage space, all users having privileges can access the files stored in the cloud storage through any electronic devices, without the need of restricting to use a mobile device or PC that receives the files. This removes a restriction on devices for accessing the files.

### BRIEF DESCRIPTION OF THE DRAWINGS

FIGS. 1-2 are schematic diagrams of interfaces of an instant communication application in a related technology.

FIG. 3 is a flowchart of a file storage method for instant communication messages on a terminal side in accordance with an illustrative embodiment of the present disclosure.

FIG. 4 is a flowchart of a file storage method for instant communication messages on a server side in accordance with an illustrative embodiment of the present disclosure.

FIG. 5 is a flowchart of a file storage method for instant communication messages in accordance with an illustrative embodiment of the present disclosure.

FIGS. 6-10 are schematic diagrams of interfaces of an instant communication application in accordance with an illustrative embodiment of the present disclosure.

FIG. 11 is a flowchart of another file storage method for instant communication messages in accordance with an illustrative embodiment of the present disclosure.

FIG. 12 is a schematic of an interface of managing a cloud storage space in accordance with an illustrative embodiment of the present disclosure.

FIG. 13 is a schematic diagram of another interface of an instant communication application in accordance with an illustrative embodiment of the present disclosure.

FIG. 14 is a schematic structural diagram of an electronic device in accordance with an illustrative embodiment of the present disclosure.

FIG. 15 is a block diagram of a file storage apparatus for instant communication messages on a terminal side in accordance with an illustrative embodiment of the present disclosure.

FIG. 16 is a schematic structural diagram of another electronic device in accordance with an illustrative embodiment of the present disclosure.

FIG. 17 is a block diagram of a file storage apparatus for instant communication messages on a server side in accordance with an illustrative embodiment of the present disclosure.

FIG. 18 is a flowchart of a method for notifying a file update in accordance with an illustrative embodiment of the present disclosure.

FIG. 19 is a schematic structural diagram of another electronic device in accordance with an illustrative embodiment of the present disclosure.

FIG. 20 is a block diagram of an apparatus for notifying a file update in accordance with an illustrative embodiment of the present disclosure.

### DETAILED DESCRIPTION

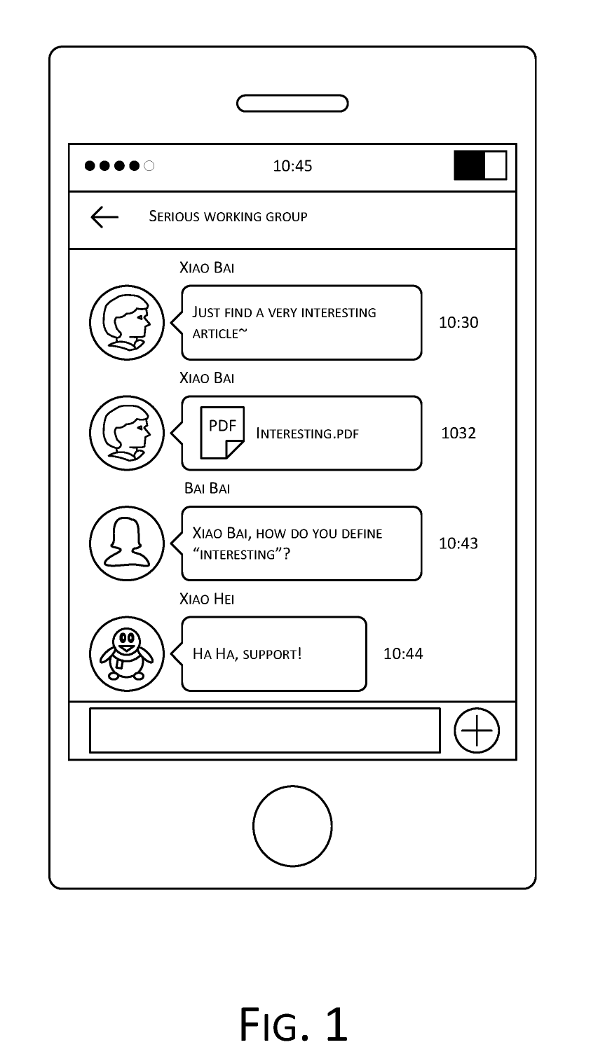

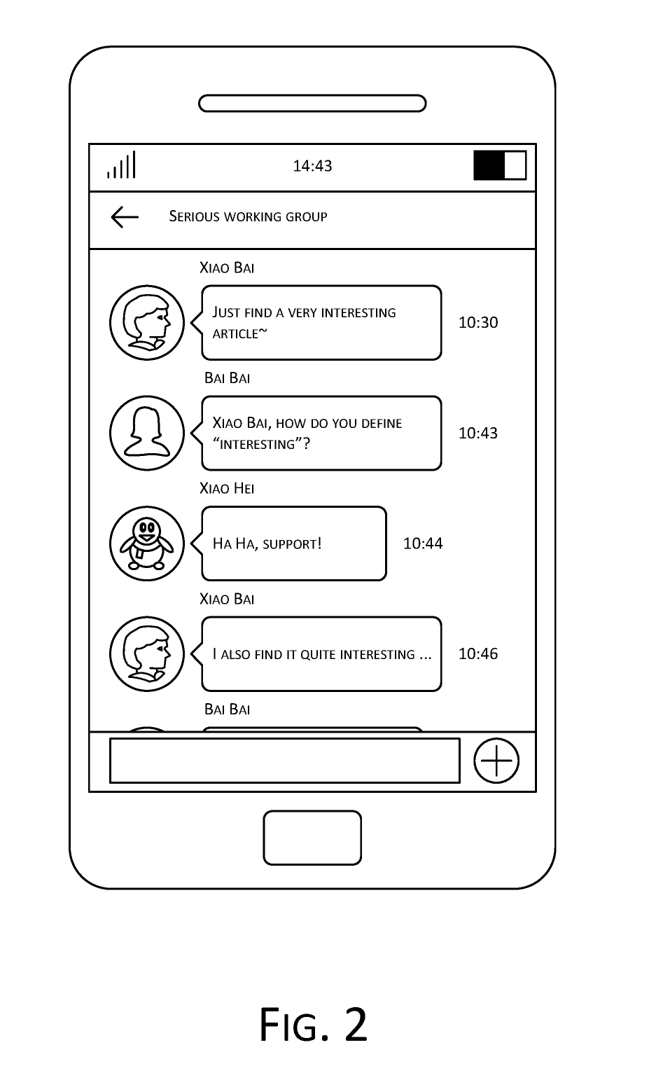

FIGS. 1-2 are schematic diagrams of interfaces of an instant communication application in a related technology. As shown in FIG. 1, a group named “serious working group” in the instant communication application is used as an example. Each member in this group can send instant communication messages, and can view these instant communication messages in an information receiving interface as shown in FIG. 1. Other than textual content, an instant communication message may also include various types of files such as an image, a document, etc. For example, a group member “Xiao Bai” as shown in FIG. 1 sends a document named “interesting.pdf”, and other group members can receive and read this file.

In order to facilitate a user to read historical messages, the related technology can record instant communication messages in a historical message file, to allow the user to read thereof at a later time. However, instant communication messages that are recorded in a historical message file are restricted and limited to textual content. Files such as the above document “interesting.pdf” are not able to be recorded into the historical message file, but can only be able to be stored in a terminal that originally receives the files, e.g., a mobile device as shown in FIG. 1. As such, after the user signs into his/her account through another terminal (e.g., after the user completes signing into a mobile device as shown in FIG. 2), the user can only view the textual content in the historical message file, and cannot browse files such as the above document “interesting.pdf”.

As can be seen, if a terminal that originally receives a file is not around, a user cannot view the file in real time. If the terminal that originally receives the file is lost or data is mistakenly deleted, the user can no longer view this file again.

Therefore, by improving a process of storing messages of an instant communication application, the present disclosure can solve the foregoing technical problems that exist in the related technology. In order to describe the present disclosure in further detail, the following embodiments are provided.

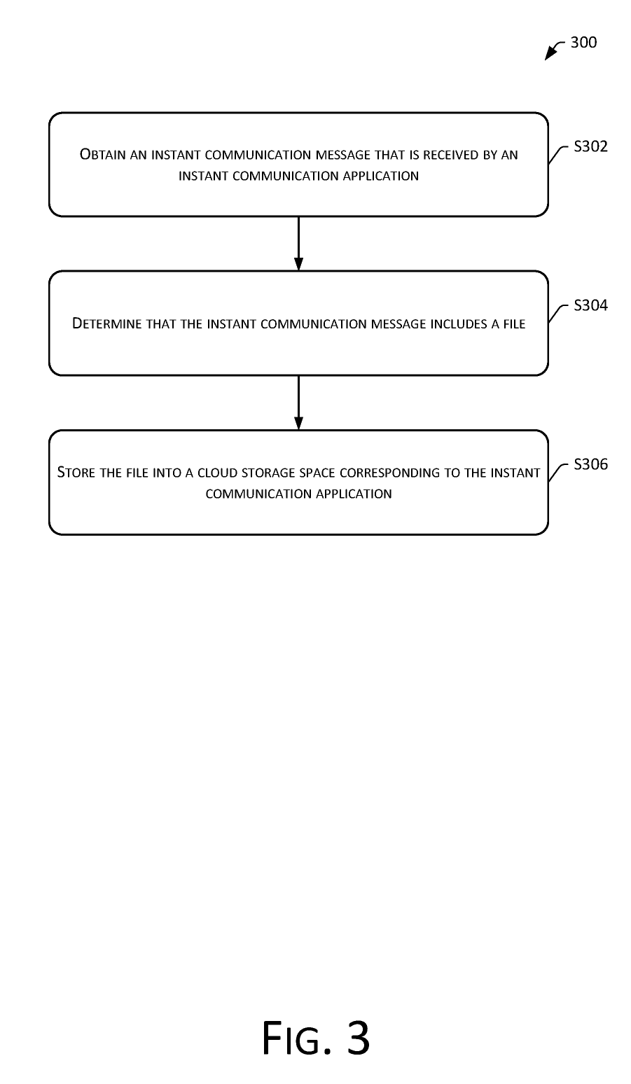

FIG. 3 is a flowchart of a storage method 300 for instant communication messages on a terminal side in accordance with an illustrative embodiment of the present disclosure. As shown in FIG. 3, the method 300 is applied in a terminal, and may include the following operations.

S302 obtains an instant communication message that is received by an instant communication application.

In implementations, an instant communication application can be any application program that can implement “instant communication”, such as an enterprise instant communication application (Enterprise Instant Messaging, EIM). An example is an enterprise instant communication application, DingTalk.

In implementations, an instant communication message can come from a message receiving window of an individual. For example, A directly sends an instant communication message to B, and so only B can receive this instant communication message. Alternatively, an instant communication message can come from a message receiving window of a group. For example, a group includes A, B, and C. After A sends the instant communication message, B and C can both receive this instant communication message.

In implementations, a terminal that receives the instant communication message may be a mobile device such as a smartphone, a tablet device, etc., or a non-mobile device such as a PC that has a desktop version of an instant communication application installed therein, for example.

S304 determines that the instant communication message includes a file.

In implementations, a “file” included in an instant communication message is only used for distinguishing from a “text”. The file may be in various types of format such as an image, a document, an audio/video, a compressed package, etc. The present disclosure does not have any limitation thereon.

S306 stores the file into a cloud storage space corresponding to the instant communication application.

In implementations, under normal situations, the terminal can directly upload a file onto a cloud storage space through the instant communication application. Alternatively, in another type of situation, if the file is originally stored in the cloud storage space (for example, the file is located at a storage space 1 corresponding to a user A in a cloud space), the file is then stored into a storage space 2 corresponding to a certain group in the cloud space when the user A sends this file to the group. In this case, the terminal does not need to upload this file, but only needs to inform the cloud storage space about information of the file, to cause the cloud storage space to copy or move the file from the storage space 1 into the storage space 2.

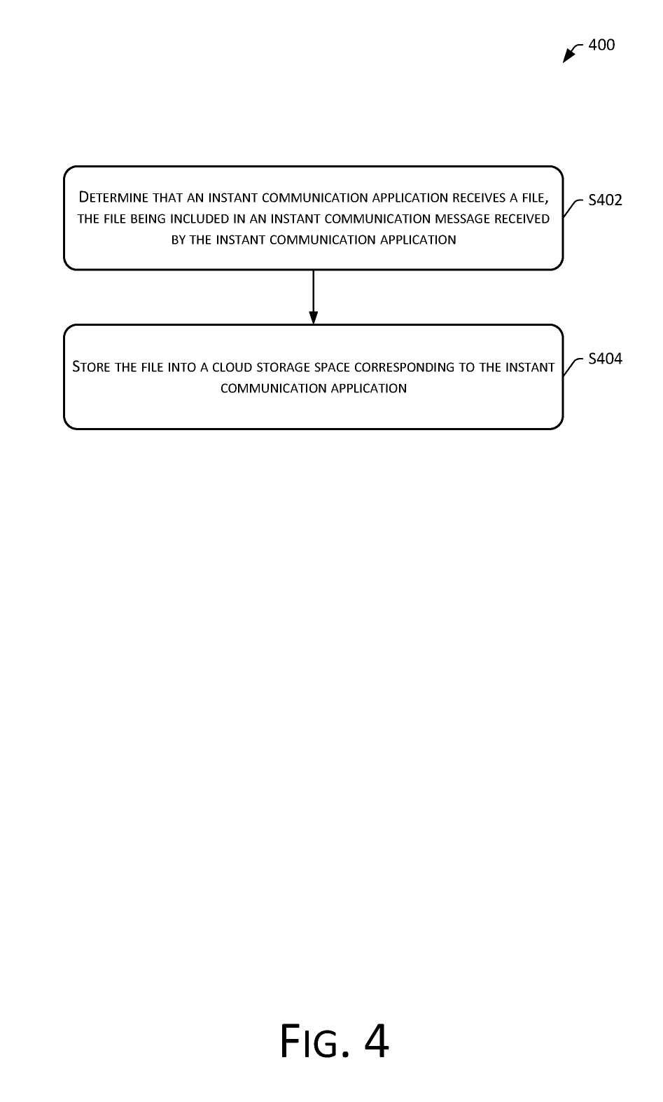

In correspondence with the embodiment shown in FIG. 3, FIG. 4 is a flowchart of a file storage method 400 for instant communication messages on a server side in accordance with an illustrative embodiment of the present disclosure. As shown in FIG. 4, the method 400 is applied in a server, and may include the following operations.

S402 determines that an instant communication application receives a file, the file being included in an instant communication message received by the instant communication application.

S404 stores the file into a cloud storage space corresponding to the instant communication application.

As can be seen from the above embodiments, by combining a cloud storage function with an instant communication application, the present disclosure enables files in the instant communication application to be automatically stored into a cloud storage space, thus facilitating a user to query and view thereof at a later time. Furthermore, as the files are stored in the cloud storage space, all users having privileges can access the files stored in the cloud storage through any electronic devices, without the need of restricting to use a mobile device or PC that receives the files. This removes a restriction on devices for accessing the files.

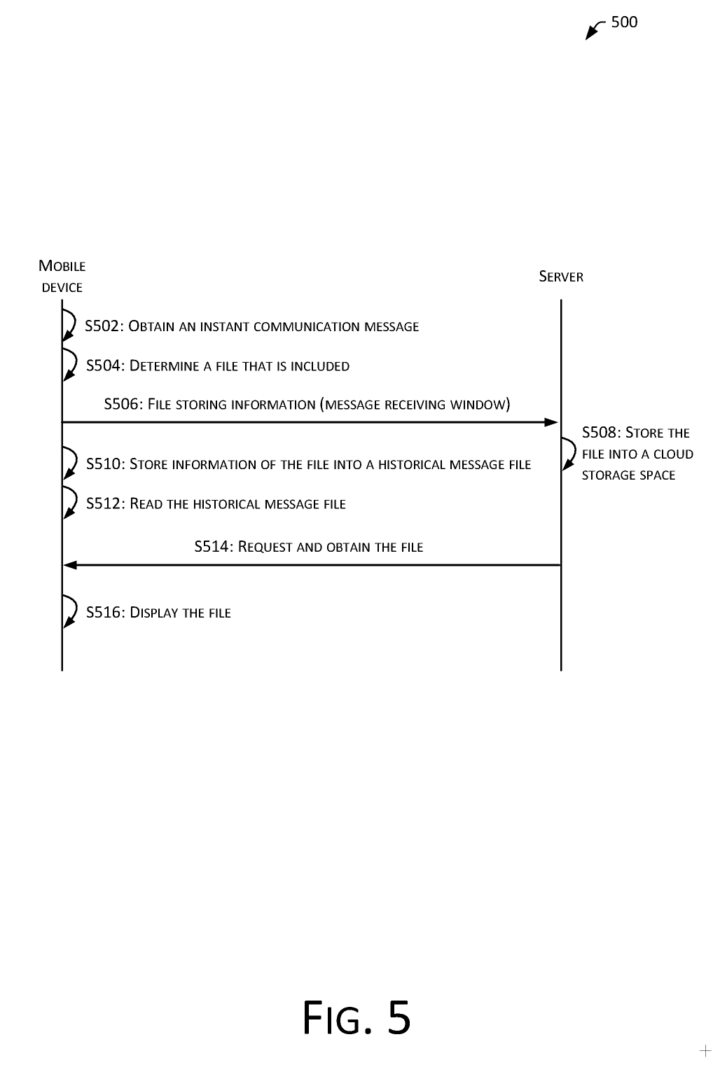

The technical solutions of the present disclosure are described in details herein in conjunction with a process of interaction between a terminal and a server. FIG. 5 is a flowchart of a file storage method 500 for instant communication messages in accordance with an illustrative embodiment of the present disclosure. As shown in FIG. 5, if a user receives an instant communication message through a mobile device, the method 500 may include the following operations.

At S502, a mobile device obtains an instant communication message received by a currently logged-in user.

At S504, the mobile device determines a file included in the instant communication message.

In implementations, the instant communication message can be received by the mobile device in real time, or can be a historical message previously received by the mobile device. Regardless, a file therein can be extracted and uploaded into a cloud storage space.

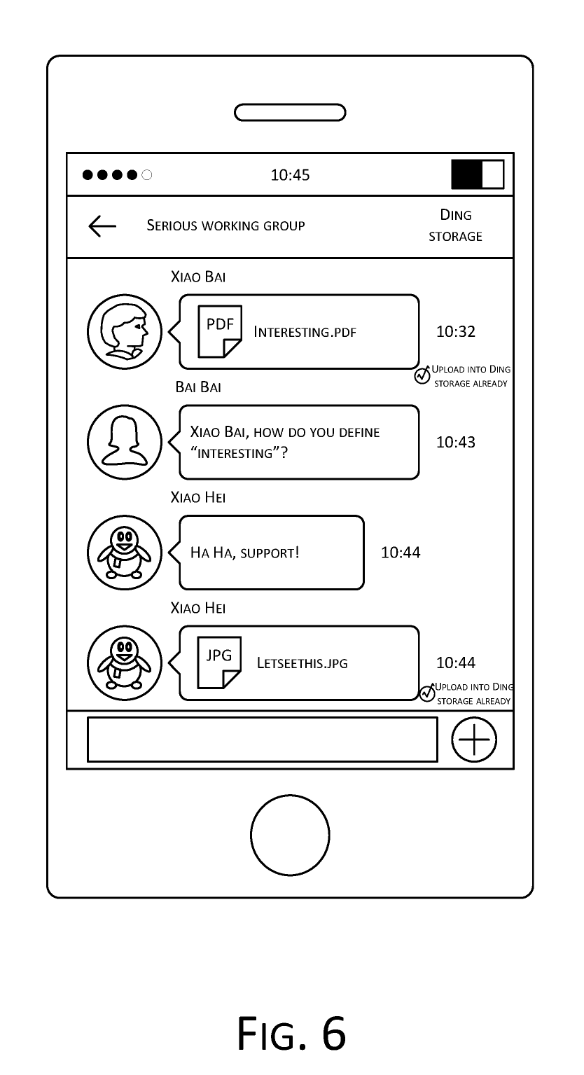

In implementations, a “file” is instant communication message content relative to a “text”, and can be in various types of format such as a document “interesting.pdf”, an image “letseethis.jpg”, etc., as shown in FIG. 6. The present disclosure does not have any limitation thereon.

At S506, the mobile device sends a file storing message to a server.

In implementations, if the file received by the mobile device has been stored in a cloud space in advance, this file storing message may include information about the file only, to cause the cloud space to copy or move the corresponding file into a new storage space. Alternatively, if the file received by the mobile device is not stored in the cloud space in advance, the file storing message may include the file, and thereby the file is uploaded and stored into the cloud space.

At S508, the server stores the file into a cloud storage space.

In implementations, the “server” is a cloud management device relative to the “mobile device”, and is loaded with functions for managing the cloud storage space.

As an illustrative embodiment, the cloud storage space may not need to be further divided into regions. In this case, all uploaded files are stored in a universal cloud storage space, to enable a user to access the cloud storage space for viewing and managing corresponding files through any terminal at any time.

As another illustrative embodiment, the mobile device may determine a message receiving window of an instant communication application to which the file belongs, and inform the server of this message receiving window. The server then stores the file into a storage space corresponding to the message receiving window in the cloud storage space. In this embodiment, by being informed of respective message receiving windows corresponding to files, a cloud storage space is enable to implement a further space division based on the message receiving windows, thus facilitating an effective management of the files.

In an illustrative implementation, the message receiving window may correspond to an organizational structure of an organizational group (group members have an organizational structure of an organization, and the organizational group is a company group if the organization is a company). The server can store the file into a shared storage space corresponding to this organizational group in the cloud storage space. Since a storage space being used is a shared storage space, multiple users can access this shared storage space, such that files therein can be shared among the multiple users. By way of examples, the “multiple users” may be all or some of the members in the organizational group, such as sharing of the files are limited to this organizational group internally, thus introducing restrictions on the sharing of the files and ensuring the security of the files.

In another illustrative implementation, the message receiving window may correspond to an individual or a non-organizational group. The server may then store the file into a personal storage space corresponding to a current logged-in user in the cloud storage space. Since a storage space that is used is a personal storage space, only the currently logged-in user can access thereto, thus ensuring a personal need of the user for the file.

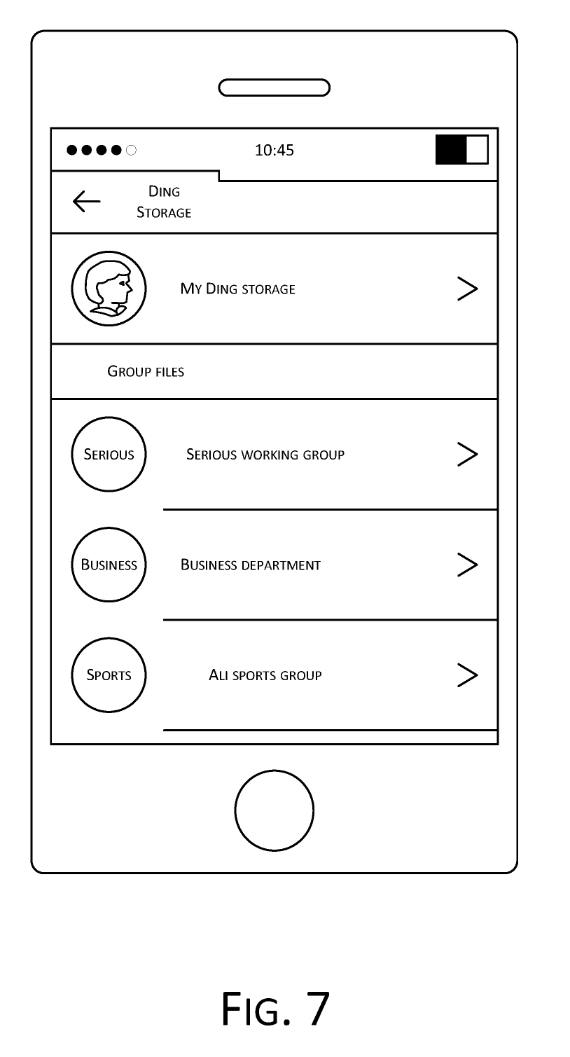

A “company group” is used as an example. As shown in FIG. 7, if a currently logged-in user joins company groups such as a “serious working group”, “business department”, and “Ali sports group” respectively, a cloud storage space individually assigns shared storage spaces for each company group (it can be understood as separately creating shared file folders for each company group). In this case, stored files can be separately placed into corresponding shared storage spaces, to facilitate searching at a later time. The server can divide the cloud storage space into corresponding shared storage spaces when each company group is created, or can divide the cloud storage space into corresponding shared storage spaces when a respective company group receives a file for the first time. Apparently, timing for creating a personal storage space is similar. For example, when a user creates an account, a corresponding personal storage space is assigned and divided from the cloud storage space. Alternatively, when the user receives a file from another user or non-organizational group for the first time, a corresponding personal storage space is assigned and divided from the cloud storage space. Apparently, the present disclosure does not have any limitation on the timing for creating a storage space.

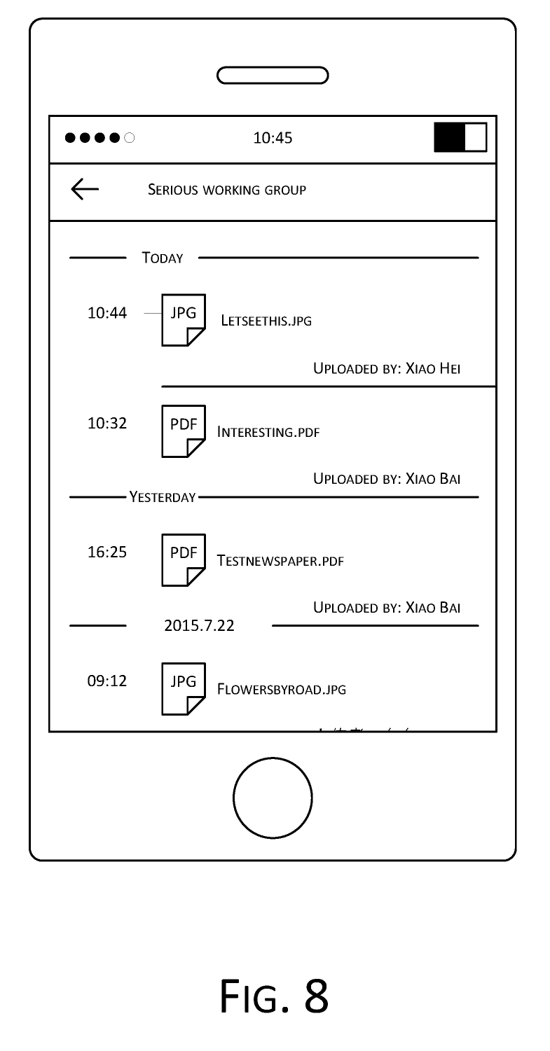

Ordered management of various preset dimensions may be performed on files stored in the cloud storage space. In an illustrative embodiment, when a time dimension is used for management, files in the cloud storage space are ordered according to an order of uploading times. When files are stored in a certain storage space, the files in this storage space can be arranged according to an order of respective uploading times. As shown in FIG. 8, for all files of the “serious working group”, an ordering is performed from the top to the bottom according to an order of dates: “today” (e.g., 2015.7.24), “yesterday” (e.g., 2015.7.23), “2015.7.22”. Files in each day are similarly arranged from the top to the bottom according to respective uploading times. For example, “letseethis.jpg” that is mostly recently uploaded at 10:44 “today” is placed above “interesting.pdf” that is uploaded at 10:32, and files of later times are ordered in the top portion of “today” accordingly.

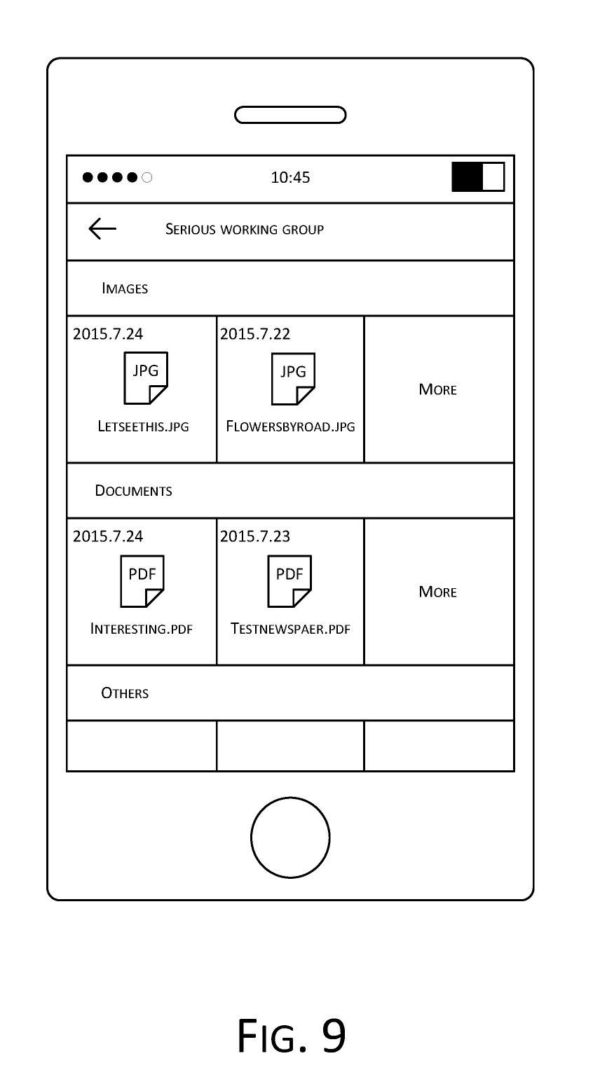

In another illustrative implementation, when a type dimension is used for management, files in the cloud storage space are managed categorially according to respective type attributes. When files are stored in a certain storage space, the files in this storage space can be categorized according to respective type attributes. As shown in FIG. 9, for all files of the “serious working group”, the files are stored and managed categorially according to categories such as “images”, “documents”, “others”, etc. For example, “letseethis.jpg” and “flowersbyroad.jpg”, etc., are categorized into “images”, and “interesting.pdf” and “textnewspaper.pdf” are categorized into “documents”.

Apparently, the cloud storage space may also perform file storage and management through other different types of dimensions. The present disclosure does not have any limitation thereon. Multiple dimensions can be applied and coordinated at the same time. For example, management can further be performed through a time dimension for files in each category. For example, “letseethis.jpg” that is received on 2015.7.24 is arranged before “flowersbyroad.jpg” that is received on 2015.7.22 under “images”.

Furthermore, the present disclosure can also implement a distinction from a process of viewing historical messages of FIGS. 1-2 based on file-based storage of a cloud storage space. The process is described in details hereinafter.

At S510, the mobile device stores information of the stored file into a historical message file.

In implementations, different from a method of storing only textual content in a historical message file in the related technology, information of the file is also stored in the historical message file. Therefore, a size of the historical message file is not made too large, and conditions of transmitting the file can also be recorded. This helps to completely recover all instant communication messages at a later time.

In implementations, the historical message file can be uploaded to the server, and stored in the cloud storage space. After the cloud storage space divides and assigns a corresponding storage space to each group, the mobile device can generate a respective historical message file for each group, and similarly upload the respective historical message file into the storage space corresponding to the group in the cloud storage space, thus enabling a user to log in via another terminal and browse instant communication messages corresponding to the historical message file.

At S512, the mobile device reads the historical message file.

At S514, the mobile device sends a request to the server, and obtains file(s) stored in the cloud storage space.

At S516, the mobile device displays the file(s).

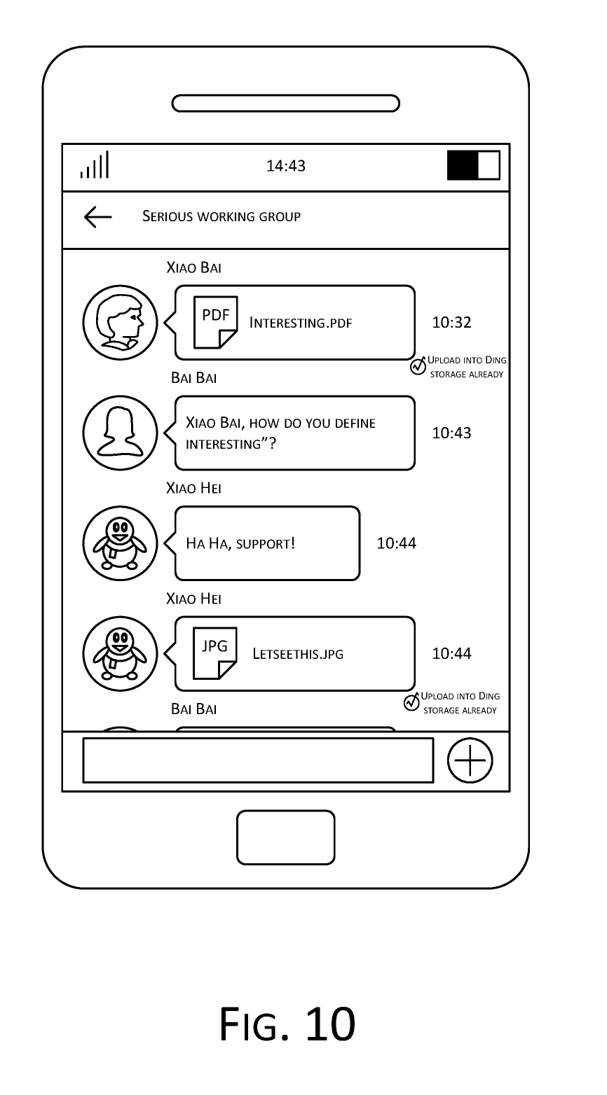

In implementations, the mobile device records information of file(s) into the historical message file of the instant communication application in advance. When the historical message file is read, the file(s) can be obtained from the cloud storage space based on the information of the file(s), and displayed in a display page of the instant communication application for the historical message file, in response to the content that is read including the information of the file(s) that has/have been uploaded. Correspondingly, although the user originally receives the instant communication message and the related file via the mobile device as shown in FIG. 6, the user can still view all the received texts and file(s) in FIG. 6 in their entirety (rather than only the textual content as shown in FIG. 2) even after the user logs in via another mobile device as shown in FIG. 10, because the file has been automatically uploaded into the cloud storage space.

Apparently, other than mobile devices, when the user logs into an instant communication application via any terminal such as a PC, data interaction with the cloud storage space can still be achieved, thus being able to view all the received texts and file(s) of FIG. 6 in their entirety.

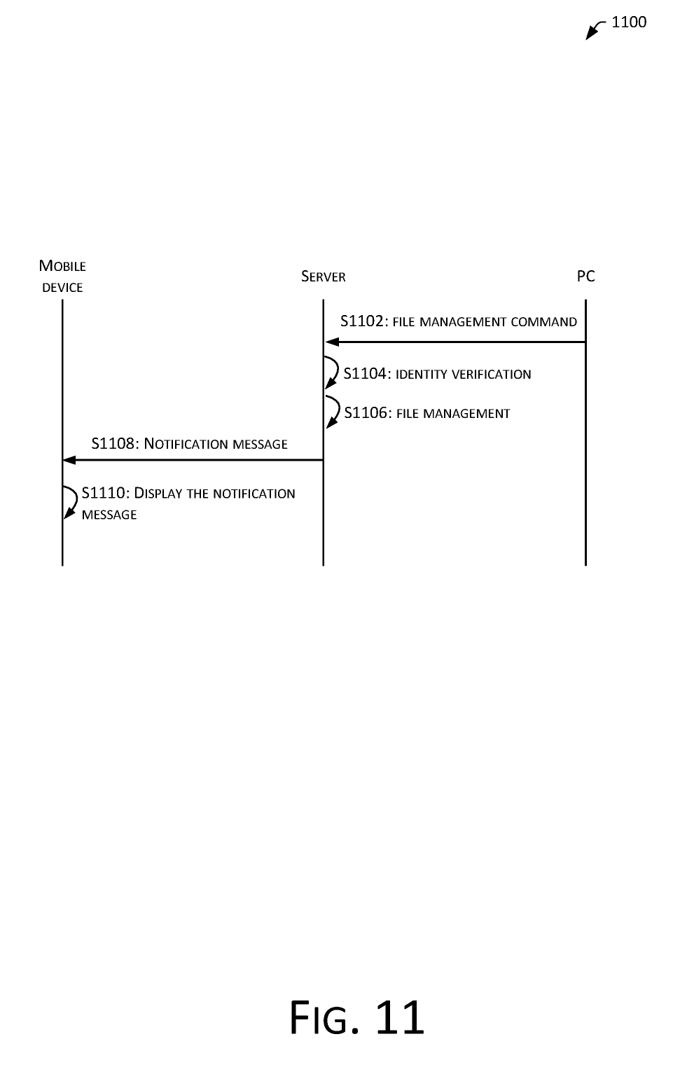

FIG. 11 is a flowchart of a file storage method 1100 for instant communication messages in accordance with an illustrative embodiment of the present disclosure. As shown in FIG. 11, the method 1100 may include the following operations.

At S1102, a PC sends a file management command to a server.

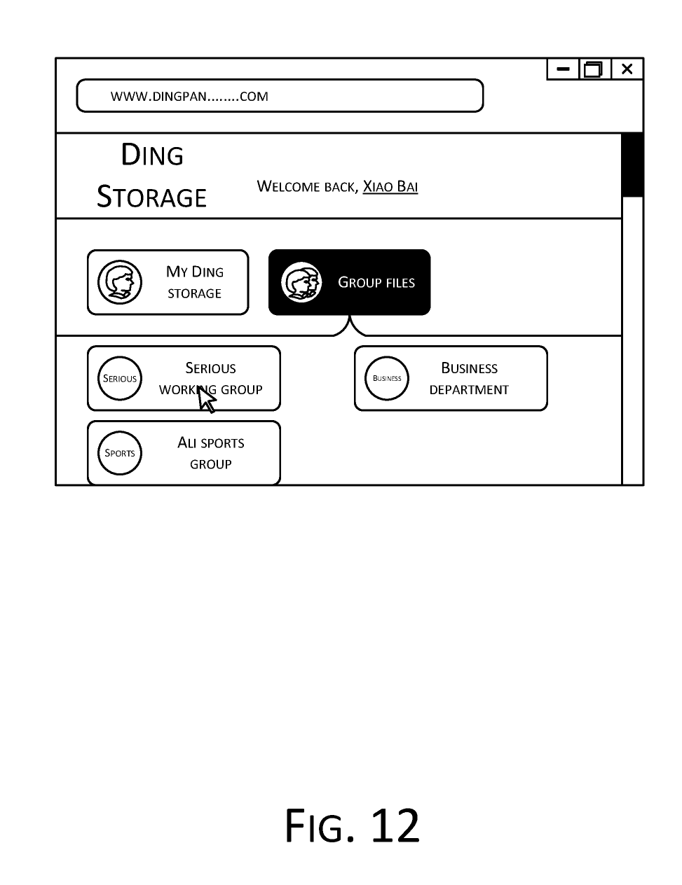

In implementations, a user is assumed to access a cloud storage space of a server through a PC, to implement file management of the cloud storage space. For example, the user may access the server through a way such as a browser in the PC or a client of an instant communication application, etc. For example, as shown in FIG. 12, if a user “Xiao Bai” accesses a cloud storage space “Ding storage” corresponding to an instant communication application “DingTalk” through a browser on a PC, the user can view groups such as “serious working group”, “business department” and “Ali sports group” that he has joined by logging into his account. By further selecting a desired group for viewing, the user can browse uploaded files in instant communication messages of that group. For example, when the user selects the “serious working group”, stored files as shown in FIG. 8 or 9 can be viewed.

Apparently, other than PC, a user can access a cloud storage space through any terminal in reality. For example, besides representing file management of a cloud storage space in multiple dimensions, FIGS. 7-9 are also schematic diagrams of interfaces when a user accesses the cloud storage space through an instant communication application on a mobile device. Specifically, the user can achieve accessing the cloud storage space by clicking a “Ding storage” button on top-right corner of a page as shown in FIG. 6 or clicking an instant communication message (such as an icon including an “interesting.pdf” file that is sent by “Xiao Bai”, for example) in a message receiving window as shown in FIG. 6.

As can be seen, by uploading and storing files into a cloud storage space, a user is no longer restricted to a terminal that originally receives the files, but can achieve accessing a file included in an instant communication message through any terminal that can connect to the Internet.

At S1104, the server performs identity verification for a currently logged-in user of the PC.

In implementations, especially in situations when an instant communication application is an enterprise instant communication application and a group is a company group, files stored in a cloud storage space may possess certain confidential requirements. Therefore, in order to improve the security of the files, an identity verification is performed on a user who accesses the cloud storage space.

By way of examples, the server can determine the currently logged-in user of the PC. When the currently-logged-in user is a member of a group that he/she desires to manage (i.e., corresponding to the “file management command”), the server determines that the currently logged-in user has a privilege of managing the group, and allows an execution of the file management command.

At S1106, file management is performed on a cloud storage space according to the file management command upon successful identity verification.

In implementations, the user performs various management operations on the files, such as a viewing operation (i.e., viewing all files that are uploaded and stored in the cloud storage space), or an editing operation (i.e., an operation such as adding, deleting, modifying a file in the cloud storage space, to implement a file update in the cloud storage space).

At S1108, a notification message is sent to a corresponding group based on a file updating event that occurs in the cloud storage space.

At S1110, the mobile device displays the notification message after receiving the notification message.

In implementations, when the user performs an editing operation such as adding, deleting or modifying a file in the cloud storage space, a file updating event occurs in the cloud storage space. In order to improve file security and transparency and to ensure all related users to be aware of a status of the cloud storage space in time, a notification may be performed for the file updating event. In other words, when a file updating event occurs in a storage space corresponding to any one group in the cloud storage space, the server sends a corresponding notification message to the instant communication application. Each member in that one group can then receive the notification message on a terminal from which a respective login is currently made. Furthermore, the notification message is displayed in a message receiving window of that one group.

For example, as shown in FIG. 6, after “Xiao Bai” sends a document “interesting.pdf” and “Xiao Hei” sends an image “letseethis.jpg”, these files are both uploaded into a cloud storage space automatically, leading to an occurrence of file updating events in a storage space of the “serious working group” in the cloud storage space. According to notification messages returned by the server, a notification message of “®uploaded into Ding storage already” is separately displayed after each uploaded file in the message receiving window of FIG. 6. As such, group members such as users “Xiao Bai”, “Xiao Hei” and “Bai Bai” can all see the notification message.

Furthermore, especially for an organizational group, since multiple users commonly use a shared storage space, the above notification message can include detailed conditions of the file updating event, to enable other users to understand thereof in time. For example, the notification message may include at least one piece of the following information: triggering user information of the file updating event, updated file information of the file updating event, or updated operation information of the file updating event.

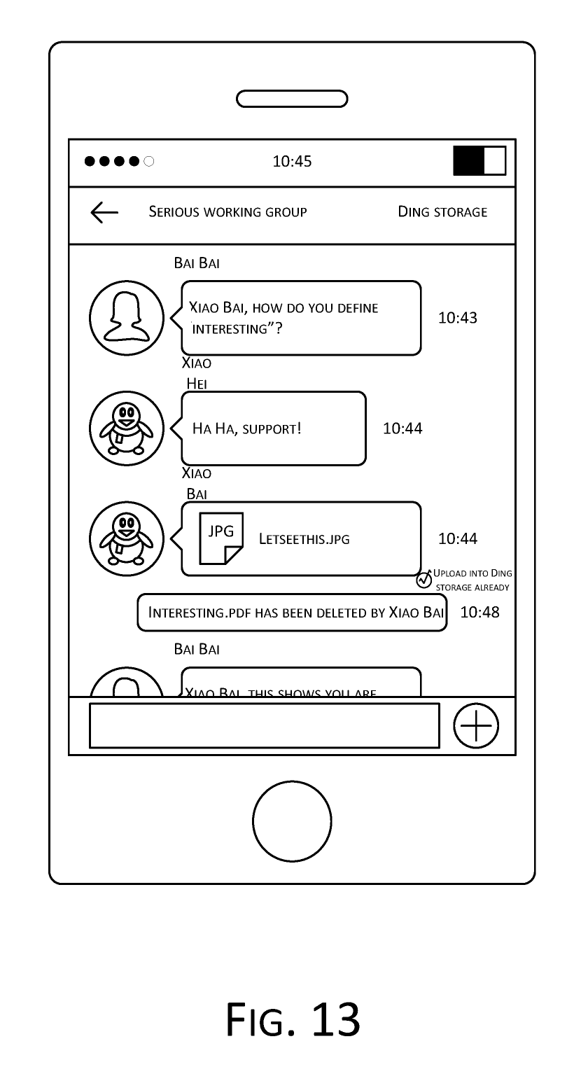

By way of examples, as shown in FIG. 13, after the user “Xiao Bai” deletes the document “interesting.pdf” through a method as shown in FIG. 12, group members such as users “Xiao Bai”, “Xiao Hei” and “Bai Bai”, etc., can all see a notification message of “interesting.pdf has been deleted by Xiao Bai”, which includes triggering user information as “Xiao Bai”, updated file information as “interesting.pdf”, and updated operation information as “deleted”.

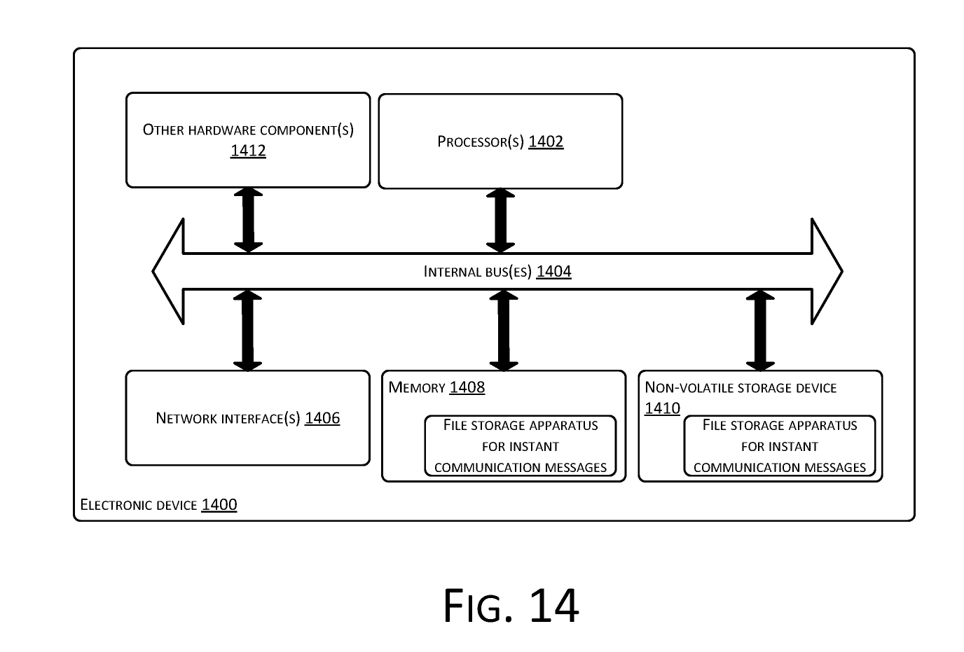

FIG. 14 shows a schematic structural diagram of an electronic device 1400 in accordance with an illustrative embodiment of the present disclosure. Referring to FIG. 14, in a hardware level, the electronic device 1400 includes processor(s) 1402, internal bus(es) 1404, network interface(s) 1406, memory 1408, and a non-volatile storage device 1410, and may apparently further include other hardware components 1412 that are needed by services. The processor(s) 1402 read(s) a corresponding computer program from the non-volatile storage device 1410 into the memory 1408 for running, to form a file storage apparatus for instant communication messages in a logical level. Apparently, other than software implementations, the present disclosure does not exclude other implementations, such as logical components, or a combination of software and hardware components, etc. In other words, execution entities of the following processes are not limited to logical units, and can be hardware or logical components.

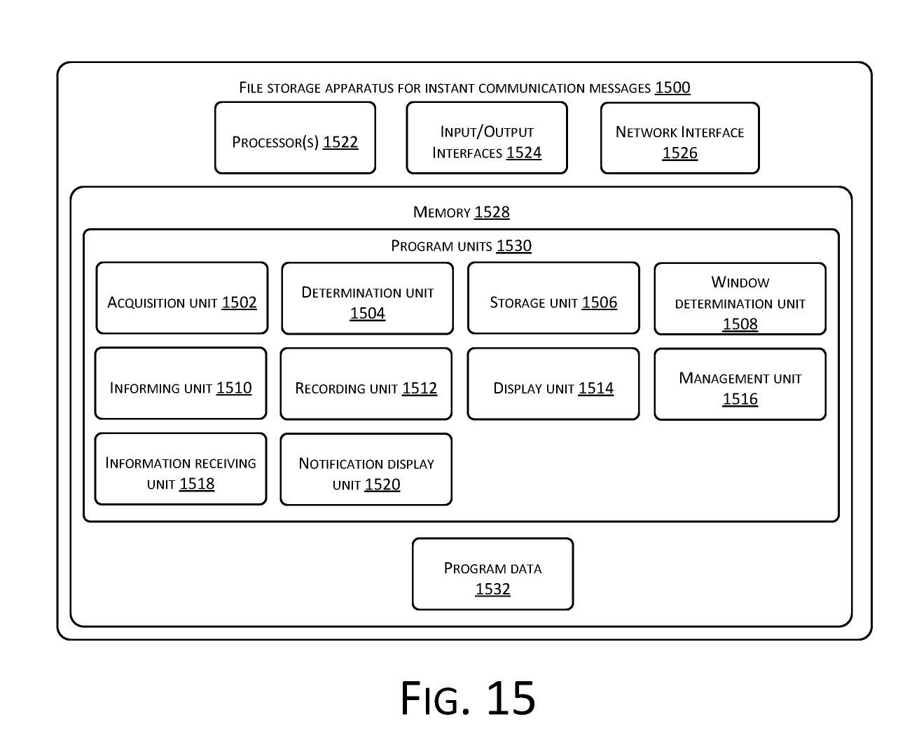

Referring to FIG. 15, a file storage apparatus 1500 for instant communication messages may include an acquisition unit 1502, a determination unit 1504, and a storage unit 1506. The acquisition unit 1502 obtains an instant communication message received by an instant communication application. The determination unit 1504 determines that a file is included in the instant communication message. The storage unit 1506 stores the file in a cloud storage space corresponding to the instant communication application.

In implementations, the apparatus 1500 further includes a window determination unit 1508 that determines a message receiving window of the instant communication message to which the file belongs; and an informing unit 1510 that informs the cloud storage pace of information about the message receiving window, to allow the file to be stored in a storage space corresponding to the message receiving window in the cloud storage space.

In implementations, when the message receiving window corresponds to an organizational group, the file is stored in a shared storage space corresponding to the organizational group in the cloud storage space. When the message receiving window corresponds to an individual or a non-organizational group, the file is stored in a personal storage space corresponding to a currently logged-in user in the cloud storage space.

In implementations, the apparatus 1500 further includes a recording unit 1512 that records information of the file into a historical message file of the instant communication application; and a display unit 1514 that obtains the file from the cloud storage space based on the information of the file and displays the file in a historical message display page of the instant communication application when the historical message file is read and read content includes the information of the file.

In implementations, the apparatus 1500 further includes a management unit 1516 that displays stored file(s) corresponding to any one group in the cloud storage space and performs management of the stored file(s) that is/are displayed in response to the instant communication application receiving a file management command for the any one group and a currently logged-in user having a management privilege on the any one group.

In implementations, the apparatus 1500 further includes an information receiving unit 1518 that receives a notification message returned by the cloud storage space, the notification message being related to a file updating event that occurs in a storage space corresponding to any one group in the cloud storage space; and a notification display unit 1520 that displays the notification message in a message receiving window of the any one group.

In implementations, the notification message includes at least one piece of the following information: triggering user information of the file updating event, updated file information of the file updating event, or updated operation information of the file updating event.

In implementations, the instant communication application is an enterprise instant communication application.

In implementations, the apparatus 1500 may further include one or more processors 1522, an input/output (I/O) interface 1524, a network interface 1526, and memory 1528.

The memory 1528 may include a form of computer readable media such as a volatile memory, a random access memory (RAM) and/or a non-volatile memory, for example, a read-only memory (ROM) or a flash RAM. The memory 1528 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 1528 may include program units 1530 and program data 1532. The program units 1530 may include one or more of the units described above.

In implementations, the apparatus 1500 may include one or more computing devices, or may be a part of one or more computing devices. In implementations, the one or more computing devices may be located locally or distributed in a network such as a cloud computing architecture or network.

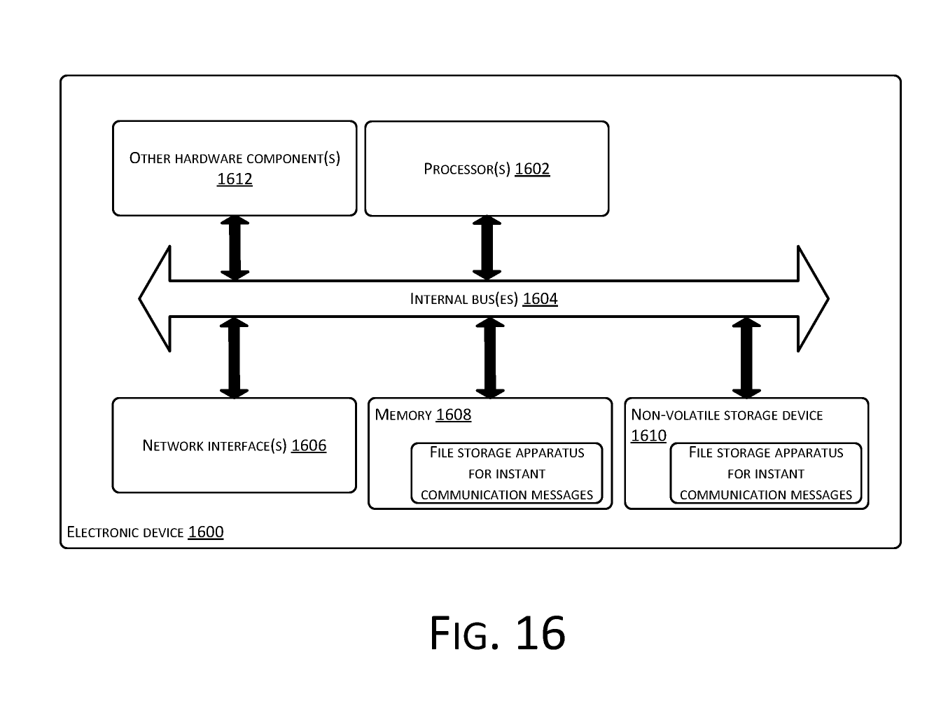

FIG. 16 shows a schematic structural diagram of an electronic device 1600 in accordance with an illustrative embodiment of the present disclosure. Referring to FIG. 16, in a hardware level, the electronic device 1600 includes processor(s) 1602, internal bus(es) 1604, network interface(s) 1606, memory 1608, and a non-volatile storage device 1610, and may apparently further include other hardware components 1612 that are needed by services. The processor(s) 1602 read(s) a corresponding computer program from the non-volatile storage device 1610 into the memory 1608 for running, to form a file storage apparatus for instant communication messages in a logical level. Apparently, other than software implementations, the present disclosure does not exclude other implementations, such as logical components, or a combination of software and hardware components, etc. In other words, execution entities of the following processes are not limited to logical units, and can be hardware or logical components.

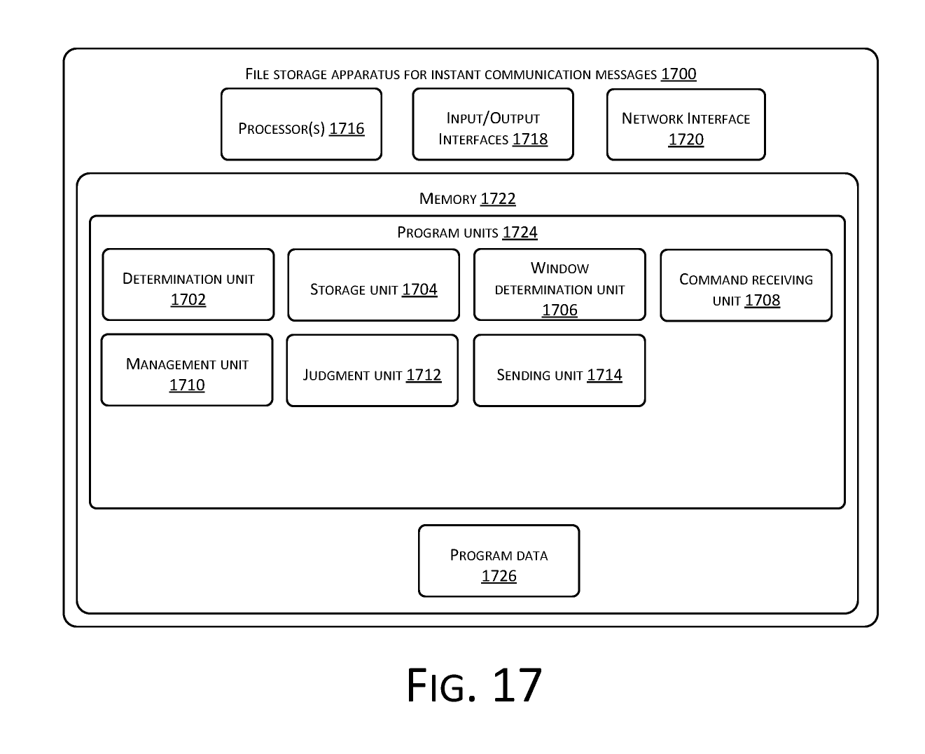

Referring to FIG. 17, a file storage apparatus 1700 for instant communication messages may include a determination unit 1702 and a storage unit 1704. The determination unit 1702 determines a file received by an instant communication application, the file being included in an instant communication message received by the instant communication application. The storage unit 1704 stores the file into a cloud storage space corresponding to the instant communication application.

In implementations, the apparatus 1700 further includes a window determination unit 1706 that determines a message receiving window of the instant communication application to which the file belongs based on a notification message of the instant communication application, wherein the storage unit 1704 stores the file into a storage space corresponding to the message receiving window in the cloud storage space.

In implementations, the storage unit 1704 is used for storing the file in a shared storage space corresponding to an organizational group in the cloud storage space when the message receiving window corresponds to the organizational group; and storing the file in a personal storage space corresponding to a currently logged-in user in the cloud storage space when the message receiving window corresponds to an individual or a non-organizational group.

In implementations, the apparatus 1700 further includes a command receiving unit 1708 that receives a file management command for any one group; and a management unit 1710 that performs management of stored file(s) corresponding to the any one group in the cloud storage space according to the file management command when an initiating user of the file management command possesses a management privilege on the any one group.

In implementations, the apparatus 1700 further includes a judgment unit 1712 that determines that the initiating user possesses the management privilege when the initiating user is a member of the any one group.

In implementations, the apparatus 1700 further includes a sending unit 1714 that sends a corresponding notification message to the instant communication application for displaying in a message receiving window that corresponds to the any one group in the instant communication application, when a file updating event occurs in a storage space corresponding to the any one group in the cloud storage space.

In implementations, the notification message includes at least one piece of the following information: triggering user information of the file updating event, updated file information of the file updating event, or updated operation information of the file updating event.

In implementations, the instant communication application is an enterprise instant communication application.

In implementations, the apparatus 1700 may further include one or more processors 1716, an input/output (I/O) interface 1718, a network interface 1720, and memory 1722. The memory 1722 may include a form of computer readable media such as the one described in the foregoing description.

In implementations, the memory 1722 may include program units 1724 and program data 1726. The program units 1724 may include one or more of the units described above.

In implementations, the apparatus 1700 may include one or more computing devices, or may be a part of one or more computing devices. In implementations, the one or more computing devices may be located locally or distributed in a network such as a cloud computing architecture or network.

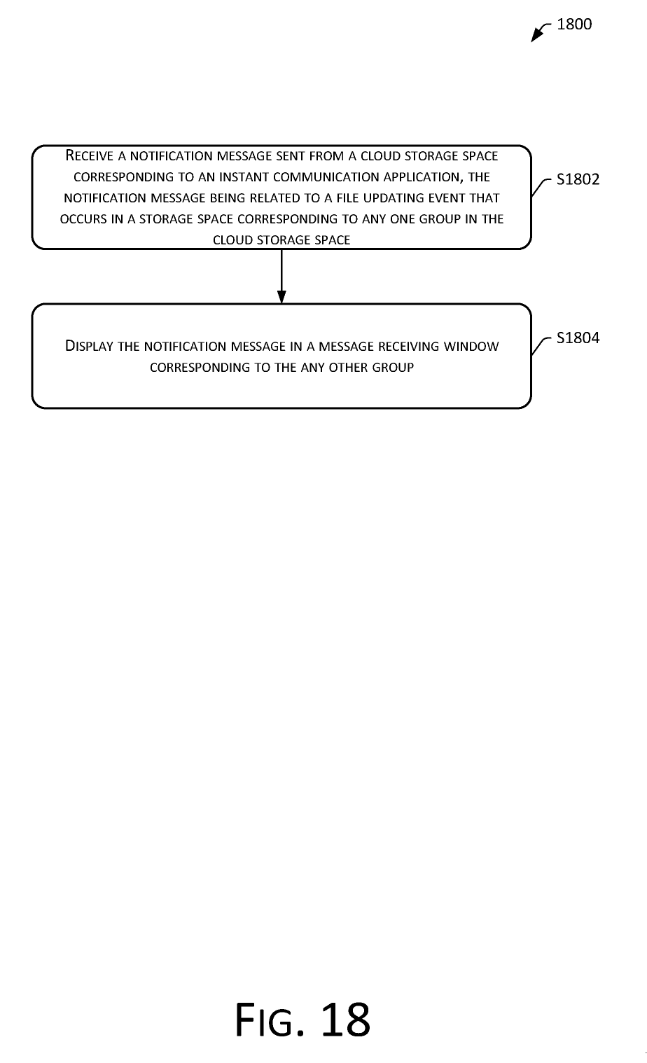

FIG. 18 is a flowchart of a method 1800 for notifying a file update in accordance with an illustrative embodiment of the present disclosure. As shown in FIG. 18, the method 1800 is applied in a terminal, and may include the following operations.

S1802 receives a notification message sent from a cloud storage space corresponding to an instant communication application, the notification message being related to a file updating event that occurs in a storage space corresponding to any one group in the cloud storage space.

S1804 displays the notification message in a message receiving window corresponding to the any other group.

In implementations, the any one group may be an organizational group, such as a company group. In this case, a corresponding storage space may be a shared storage space. In other words, all or some of members in the any one group can commonly use this shared storage space, and share files in the shared storage space. In this way, this helps file sharing among these users without the need of individually transmitting the files among the users on the one hand. On the other hand, since sharing users are limited to the members in that group, corresponding privilege restrictions exist, thus ensuring the security of the files.

When the storage space is a shared storage space, since a plurality of users can access files in this storage space, a notification message associated with the file updating event is displayed in the instant communication application. This can enable these users to understand this file updating event, and thus take hold of a status in real time.

In implementations, the notification message includes at least one piece of the following information: triggering user information of the file updating event, updated file information of the file updating event, or updated operation information of the file updating event. In this embodiment, by including the above information in the notification message, a user can directly understand information and an actual situation of the file updating event, without the need of querying and viewing conditions of files in the shared storage space, thus helping to improve the efficiency of file management.

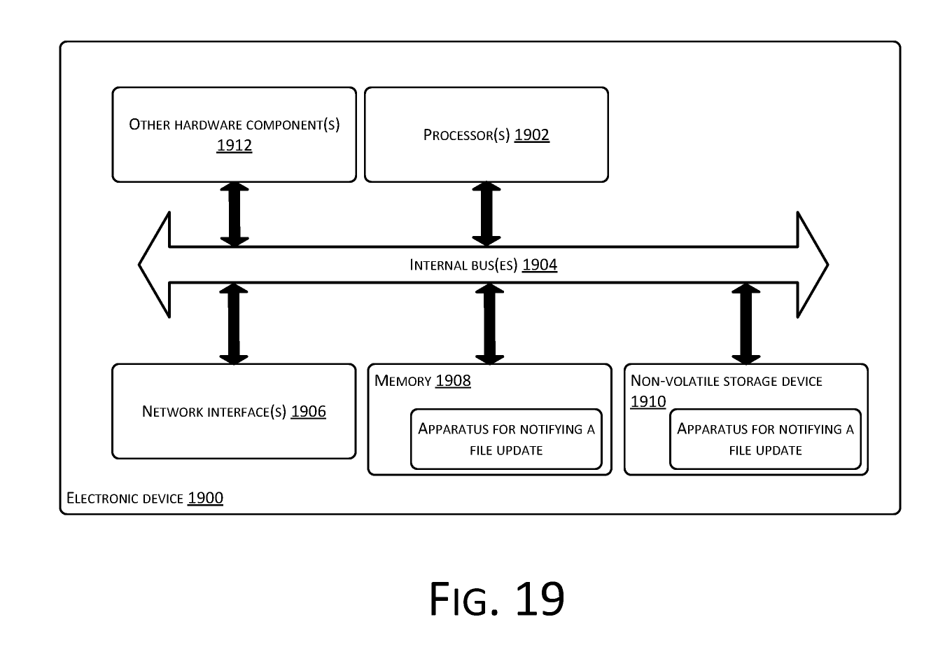

FIG. 19 is a schematic structural diagram of an electronic device 1900 in accordance with an illustrative embodiment of the present disclosure. Referring to FIG. 19, in a hardware level, the electronic device 1900 includes processor(s) 1902, internal bus(es) 1904, network interface(s) 1906, memory 1908, and a non-volatile storage device 1910, and may apparently further include other hardware components 1912 that are needed by services. The processor(s) 1902 read(s) a corresponding computer program from the non-volatile storage device 1910 into the memory 1908 for running, to form an apparatus for notifying a file update in a logical level. Apparently, other than software implementations, the present disclosure does not exclude other implementations, such as logical components, or a combination of software and hardware components, etc. In other words, execution entities of the following processes are not limited to logical units, and can be hardware or logical components.

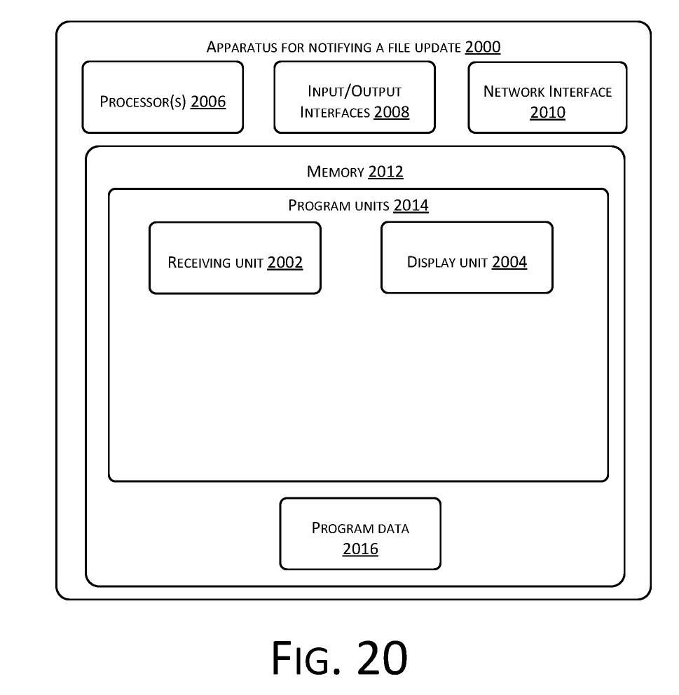

Referring to FIG. 20, an apparatus 2000 for notifying a file update may include a receiving unit 2002 and a display unit 2004. The receiving unit 2002 receives a notification message from a cloud storage space that corresponds to an instant communication application, the notification message being related to an occurrence of a file update in a storage space of the cloud storage space corresponding to any one group. The display unit 2004 presents the notification message in a message receiving window of the any one group.

In implementations, the notification message includes at least one piece of the following information: triggering user information of the file updating event, updated file information of the file updating event, or updated operation information of the file updating event.

In implementations, the apparatus 2000 may further include one or more processors 2006, an input/output (I/O) interface 2008, a network interface 2010, and memory 2012. The memory 2012 may include a form of computer readable media such as the ones described in the foregoing description.

In implementations, the memory 2012 may include program units 2014 and program data 2016. The program units 2014 may include one or more of the units described above.

In implementations, the apparatus 2000 may include one or more computing devices, or may be a part of one or more computing devices. In implementations, the one or more computing devices may be located locally or distributed in a network such as a cloud computing architecture or network.

In a typical configuration, a computing device includes one or more processors (CPU), an input/output interface, a network interface, and memory. The memory may include a form of computer readable media such as a volatile memory, a random access memory (RAM) and/or a non-volatile memory, for example, a read-only memory (ROM) or a flash RAM. The memory is an example of a computer readable media as described in the foregoing description.

It should be further noted that terms such as “include”, “comprise” or other variations thereof are intended to cover non-exclusive inclusion, so that a process, method, article or device including a series of elements not only includes the elements, but also includes other elements not explicitly listed, or further includes inherent elements of the process, method, article or device. Without further restrictions, an element defined by a phrase “include a/an . . . ” does not exclude other same elements to exist in a process, method, article, or device that includes the element.

The foregoing description merely describes exemplary embodiments of the present disclosure, which are not used for limiting the present disclosure. Any modifications, equivalent replacements, improvements, etc., that are made in the spirits and principles of the present disclosure are all covered by the scope of protection of the present disclosure.

The present disclosure may be further understood with clauses as follows.

Clause 1: A file storage method for instant communication messages, comprising: obtaining an instant communication message received by an instant communication application; determining that a file is included in the instant communication message; and storing the file in a cloud storage space corresponding to the instant communication application.

Clause 2: The method of Clause 1, further comprising: determining a message receiving window of the instant communication application to which the file belongs; and informing the cloud storage space about information of the message receiving window, to cause the file to be stored in a storage space corresponding to the message receiving window in the cloud storage space.

Clause 3: The method of Clause 2, wherein: when the message receiving window corresponds to an organizational group, the file is stored in a shared storage space corresponding to the organizational group in the cloud storage space; and when the message receiving window corresponds to an individual or a non-organizational group, the file is stored in a personal storage space corresponding to a currently logged-in user in the cloud storage space.

Clause 4: The method of Clause 1, further comprising: recording information of the file into a historical message file of the instant communication application; and obtaining the file from the cloud storage space based on the information of the file and presenting the file in a historical message display page of the instant communication application when the historical message file is read and read content includes the information of the file.

Clause 5: The method of Clause 1, further comprising displaying a stored file corresponding to any one group in the cloud storage space and performing management of the stored file that is displayed in response to the instant communication application receiving a file management command for the any one group and a currently logged-in user having a management privilege on the any one group.

Clause 6: The method of Clause 1, further comprising: receiving a notification message returned by the cloud storage space, the notification message being related to a file updating event that occurs in a storage space corresponding to any one group in the cloud storage space; and displaying the notification message in a message receiving window of the any one group.

Clause 7: The method of Clause 6, wherein the notification message includes at least one of: triggering user information of the file updating event, updated file information of the file updating event, or updated operation information of the file updating event.

Clause 8: The method of Clause 1, wherein the instant communication application is an enterprise instant communication application.

Clause 9: A file storage method for instant communication messages, comprising: determining a file received by an instant communication application, the file being included in an instant communication message received by the instant communication application; and storing the file into a cloud storage space corresponding to the instant communication application.

Clause 10: The method of Clause 9, further comprising: determining a message receiving window of the instant communication application to which the file belongs based on a notification message of the instant communication application; and storing the file into a storage space corresponding to the message receiving window in the cloud storage space.

Clause 11: The method of Clause 10, wherein storing the file into the storage space corresponding to the message receiving window in the cloud storage space comprises: storing the file in a shared storage space corresponding to an organizational group in the cloud storage space when the message receiving window corresponds to the organizational group; and storing the file in a personal storage space corresponding to a currently logged-in user in the cloud storage space when the message receiving window corresponds to an individual or a non-organizational group.

Clause 12: The method of Clause 9, further comprising: receiving a file management command for any one group; and performing management of a stored file corresponding to the any one group in the cloud storage space according to the file management command when an initiating user of the file management command possesses a management privilege on the any one group.

Clause 13: The method of Clause 12, further comprising determining that the initiating user possesses the management privilege when the initiating user is a member of the any one group.

Clause 14: The method of Clause 9, further comprising sending a corresponding notification message to the instant communication application for displaying in a message receiving window that corresponds to any one group in the instant communication application, in response to an occurrence of a file updating event in a storage space corresponding to the any one group in the cloud storage space.

Clause 15: The method of Clause 14, wherein the notification message includes at least one of: triggering user information of the file updating event, updated file information of the file updating event, or updated operation information of the file updating event.

Clause 16: The method of Clause 9, wherein the instant communication application is an enterprise instant communication application.

Clause 17: A file storage apparatus for instant communication messages, comprising: an acquisition unit to obtain an instant communication message received by an instant communication application; a determination unit to determine that a file is included in the instant communication message; and a storage unit to store the file in a cloud storage space corresponding to the instant communication application.

Clause 18: The apparatus of Clause 17, further comprising: a window determination unit to determine a message receiving window of the instant communication application to which the file belongs; and an informing unit to inform the cloud storage space of the message receiving window, to cause the file to be stored in a storage space corresponding to the message receiving window in the cloud storage space.

Clause 19: The apparatus of Clause 18, wherein: when the message receiving window corresponds to an organizational group, the file is stored in a shared storage space corresponding to the organizational group in the cloud storage space; and when the message receiving window corresponds to an individual or a non-organizational group, the file is stored in a personal storage space corresponding to a currently logged-in user in the cloud storage space.

Clause 20: The apparatus of Clause 17, further comprising: a recording unit to record information of the file into a historical message file of the instant communication application; and a display unit to obtain the file from the cloud storage space based on the information of the file and present the file in a historical message display page of the instant communication application when the historical message file is read and read content includes the information of the file.

Clause 21: The apparatus of Clause 17, further comprising a management unit to display a stored file corresponding to any one group in the cloud storage space and to perform management of the stored file that is displayed in response to the instant communication application receiving a file management command for the any one group and a currently logged-in user having a management privilege on the any one group.

Clause 22: The apparatus of Clause 17, further comprising: an information receiving unit to receive a notification message returned by the cloud storage space, the notification message being related to a file updating event that occurs in a storage space corresponding to any one group in the cloud storage space; and a notification display unit to display the notification message in a message receiving window of the any one group.

Clause 23: The apparatus of Clause 22, wherein the notification message includes at least one of: triggering user information of the file updating event, updated file information of the file updating event, or updated operation information of the file updating event.

Clause 24: The apparatus of Clause 17, wherein the instant communication application is an enterprise instant communication application.

Clause 25: A file storage apparatus for instant communication messages, comprising: a determination unit to determine a file received by an instant communication application, the file being included in an instant communication message received by the instant communication application; and A storage unit to store the file into a cloud storage space corresponding to the instant communication application.

Clause 26: The apparatus of Clause 25, further comprising a window determination unit to determine a message receiving window of the instant communication application to which the file belongs based on a notification message of the instant communication application, wherein the storage unit stores the file into a storage space corresponding to the message receiving window in the cloud storage space.

Clause 27: The apparatus of Clause 26, wherein the storage unit is used for storing the file in a shared storage space corresponding to an organizational group in the cloud storage space when the message receiving window corresponds to the organizational group; and storing the file in a personal storage space corresponding to a currently logged-in user in the cloud storage space when the message receiving window corresponds to an individual or a non-organizational group.

Clause 28: The apparatus of Clause 25, further comprising: a command receiving unit to receive a file management command for any one group; and a management unit to perform management of a stored file corresponding to the any one group in the cloud storage space according to the file management command when an initiating user of the file management command possesses a management privilege on the any one group.

Clause 29: The apparatus of Clause 28, further comprising a judgment unit to determine that the initiating user possesses the management privilege when the initiating user is a member of the any one group.

Clause 30: The apparatus of Clause 25, further comprising a sending unit to send a corresponding notification message to the instant communication application for displaying in a message receiving window that corresponds to any one group in the instant communication application, in response to an occurrence of a file updating event in a storage space corresponding to the any one group in the cloud storage space.

Clause 31: The apparatus of Clause 30, wherein the notification message includes at least one of: triggering user information of the file updating event, updated file information of the file updating event, or updated operation information of the file updating event.

Clause 32: The apparatus of Clause 25, wherein the instant communication application is an enterprise instant communication application.

Clause 33: A method for notifying a file update, comprising: receiving a notification message from a cloud storage space that corresponds to an instant communication application, the notification message being related to an occurrence of a file update in a storage space of the cloud storage space corresponding to any one group; and presenting the notification message in a message receiving window of the any one group.

Clause 34: The method of Clause 33, wherein the notification message includes at least one of: triggering user information of the file updating event, updated file information of the file updating event, or updated operation information of the file updating event.

Clause 35: An apparatus for notifying a file update, comprising: a receiving unit to receive a notification message from a cloud storage space that corresponds to an instant communication application, the notification message being related to an occurrence of a file update in a storage space of the cloud storage space corresponding to any one group; and a display unit to present the notification message in a message receiving window of the any one group.

Clause 36: The apparatus of Clause 35, wherein the notification message includes at least one of: triggering user information of the file updating event, updated file information of the file updating event, or updated operation information of the file updating event.

What is claimed is:

1. A method implemented by one or more computing devices, the method comprising:
obtaining an instant communication message received by an instant communication application;
determining that a file is included in the instant communication message; and
storing the file in a cloud storage space corresponding to the instant communication application.

2. The method of claim 1, further comprising:
determining a message receiving window of the instant communication application to which the file belongs; and
informing the cloud storage space about information of the message receiving window, to cause the file to be stored in a storage space corresponding to the message receiving window in the cloud storage space.

3. The method of claim 2, wherein:
when the message receiving window corresponds to an organizational group, the file is stored in a shared storage space corresponding to the organizational group in the cloud storage space; and
when the message receiving window corresponds to an individual or a non-organizational group, the file is stored in a personal storage space corresponding to a currently logged-in user in the cloud storage space.

4. The method of claim 1, further comprising:
recording information of the file into a historical message file of the instant communication application; and
obtaining the file from the cloud storage space based on the information of the file and presenting the file in a historical message display page of the instant communication application when the historical message file is read and read content includes the information of the file.

5. The method of claim 1, further comprising displaying a stored file corresponding to any one group in the cloud storage space and performing management of the stored file that is displayed in response to the instant communication application receiving a file management command for the any one group and a currently logged-in user having a management privilege on the any one group.

6. The method of claim 1, further comprising:
receiving a notification message returned by the cloud storage space, the notification message being related to a file updating event that occurs in a storage space corresponding to any one group in the cloud storage space; and
displaying the notification message in a message receiving window of the any one group.

7. The method of claim 6, wherein the notification message includes at least one of:
triggering user information of the file updating event, updated file information of the file updating event, or updated operation information of the file updating event.

8. The method of claim 1, wherein the instant communication application is an enterprise instant communication application.

9. One or more computer-readable media storing executable instructions that, when executed by one or more processors, cause the one or more processors to perform acts comprising:
determining a file received by an instant communication application, the file being included in an instant communication message received by the instant communication application; and
storing the file into a cloud storage space corresponding to the instant communication application.

10. The one or more computer-readable media of claim 9, the acts further comprising:
determining a message receiving window of the instant communication application to which the file belongs based on a notification message of the instant communication application; and
storing the file into a storage space corresponding to the message receiving window in the cloud storage space.

11. The one or more computer-readable media of claim 10, wherein storing the file into the storage space corresponding to the message receiving window in the cloud storage space comprises:
storing the file in a shared storage space corresponding to an organizational group in the cloud storage space when the message receiving window corresponds to the organizational group; and
storing the file in a personal storage space corresponding to a currently logged-in user in the cloud storage space when the message receiving window corresponds to an individual or a non-organizational group.

12. The one or more computer-readable media of claim 9, the acts further comprising:
receiving a file management command for any one group; and
performing management of a stored file corresponding to the any one group in the cloud storage space according to the file management command when an initiating user of the file management command possesses a management privilege on the any one group.

13. The one or more computer-readable media of claim 12, the acts further comprising determining that the initiating user possesses the management privilege when the initiating user is a member of the any one group.

14. The one or more computer-readable media of claim 9, the acts further comprising sending a corresponding notification message to the instant communication application for displaying in a message receiving window that corresponds to any one group in the instant communication application, in response to an occurrence of a file updating event in a storage space corresponding to the any one group in the cloud storage space.

15. The one or more computer-readable media of claim 14, wherein the notification message includes at least one of: triggering user information of the file updating event, updated file information of the file updating event, or updated operation information of the file updating event.

16. The one or more computer-readable media of claim 9, wherein the instant communication application is an enterprise instant communication application.

17. An apparatus comprising:
one or more processors;
memory;
a receiving unit stored in the memory and executable by the one or more processors to receive a notification message from a cloud storage space that corresponds to an instant communication application, the notification message being related to an occurrence of a file updating event in a storage space of the cloud storage space corresponding to any one group; and
a display unit stored in the memory and executable by the one or more processors to present the notification message in a message receiving window of the any one group.

18. The apparatus of claim 17, wherein the notification message includes at least one of: triggering user information of the file updating event, updated file information of the file updating event, or updated operation information of the file updating event.

19. The apparatus of claim 17, wherein the instant communication application is an enterprise instant communication application.

20. The apparatus of claim 17, wherein the file updating event comprises one of adding, deleting or modifying a file.
